(19) United States
(12) Patent Application Publication
(10) Pub. No.: US 2021/0359714 A1
(43) Pub. Date: Nov. 18, 2021

(54) MULTI-PATH AND JAMMING RESISTANT 5G MM-WAVE BEAMFORMER ARCHITECTURES

(71) Applicant: Mobix Labs, Inc., Irvine, CA (US)

(72) Inventors: Oleksandr Gorbachov, Irvine, CA (US); Lisette L. Zhang, Irvine, CA (US)

(21) Appl. No.: 17/318,072

(22) Filed: May 12, 2021

Related U.S. Application Data
(60) Provisional application No. 63/024,751, filed on May 14, 2020.

(51) Int. Cl. H04B 1/44; H04B 1/3805; H04B 1/04; H04B 7/06

(52) U.S. Cl. CPC H04B 1/44; H04B 1/3805; H04B 2001/3811; H04B 7/0617; H04B 2001/0416; H04B 1/04

(57) ABSTRACT

A phased array beamformer circuit connectible to an array of antenna elements has RF input/output ports, and splitter-combiners with a combined port and one or more split ports. Transmit/receive circuits are connected to the split ports and to the antenna elements of the array. The transmit/receive circuits have transmit chain and a receive chain, with power sense circuits connected thereto that output reception power level signals corresponding to detected power levels of signals through the receive chain. Gain controllers connected to each of the receive chains and to the power sense circuits adjust the gain of the receive chains based upon control signals outputted thereby.

### CROSS-REFERENCE TO RELATED APPLICATIONS

This application relates to and claims the benefit of U.S. Provisional Application No. 63/024,751 filed May 14, 2020 and entitled “MULTI-PATH AND JAMMING RESISTANT 5G MM-WAVE BEAMFORMER ARCHITECTURES” the disclosure of which is wholly incorporated by reference in its entirety herein.

### STATEMENT RE: FEDERALLY SPONSORED RESEARCH/DEVELOPMENT

Not Applicable

### BACKGROUND

### 1. Technical Field

The present disclosure relates generally to radio frequency (RF) communications devices, and more particularly, to multi-path and jamming resistant 5G millimeter wave beamformer architectures.

### 2. Related Art

Wireless communications systems find applications in numerous contexts involving information transfer over long and short distances alike, and a wide range of modalities tailored for each need have been developed. Chief among these systems with respect to popularity and deployment is the mobile or cellular phone. Generally, wireless communications utilize a radio frequency carrier signal that is modulated to represent data, and the modulation, transmission, receipt, and demodulation of the signal conform to a set of standards for coordination of the same. Many different mobile communication technologies or air interfaces exist, including GSM (Global System for Mobile Communications), EDGE (Enhanced Data rates for GSM Evolution), and UMTS (Universal Mobile Telecommunications System).

Various generations of these technologies exist and are deployed in phases, the latest being the 5G broadband cellular network system. 5G is characterized by significant improvements in data transfer speeds resulting from greater bandwidth that is possible because of higher operating frequencies compared to 4G and earlier standards. The air interfaces for 5G networks are comprised of two frequency bands, frequency range 1 (FR1), the operating frequency of which being below 6 GHz with a maximum channel bandwidth of 100 MHz, and frequency range 2 (FR2), the operating frequency of which being above 24 GHz with a channel bandwidth between 50 MHz and 400 MHz. The latter is commonly referred to as millimeter wave (mmWave) frequency range. Although the higher operating frequency bands, and mmWave/FR2 in particular, offer the highest data transfer speeds, the transmission distance of such signals may be limited. Furthermore, signals at this frequency range may be unable to penetrate solid obstacles. To overcome these limitations while accommodating more connected devices, various improvements in cell site and mobile device architectures have been developed.

One such improvement is the use of multiple antennas at both the transmission and reception ends, also referred to as MIMO (multiple input, multiple output), which is understood to increase capacity density and throughput. A series of antennas may be arranged in a single or multi-dimensional array, and further, may be employed for beamforming where radio frequency signals are shaped to point in a specified direction of the receiving device. A transmitter circuit feeds the signal to each of the antennas with the phase of the signal as radiated from each of the antennas being varied over the span of the array. The collective signal to the individual antennas may have a narrower beam width, and the direction of the transmitted beam may be adjusted based upon the constructive and destructive interferences from each antenna resulting from the phase shifts. Beamforming may be used in both transmission and reception, and the spatial reception sensitivity may likewise be adjusted.

In further detail, a typical 5G mm-wave beamformer architecture includes a single RF signal input port and multiple antennas. The transmit signal at the defined carrier frequency is applied to the RF signal input port. The input signal is split into multiple chains using a splitter circuit, which may be a Wilkinson-type splitter. The split portions of the RF input signal are passed to individual transmit chains that may each comprise a phase shifter, a variable gain amplifier (VGA), and a power amplifier (PA), the output of which is connected to a single antenna element.

This interface circuit between the single RF signal input port and the antenna array is configured for receive operations as well, and includes individual receive chains, some of the components of which are shared with the transmit chain. The receive chain includes a low noise amplifier (LNA) and a variable gain amplifier, with the input to the low noise amplifier being connected to a single antenna element. There is an intermediate RF switch, typically of the single pole, double throw type in which the pole terminal is connected to the antenna, the first throw terminal is connected to the transmit chain (e.g., the output of the power amplifier), and the second throw terminal is connected to the receive chain (e.g., the input of the low noise amplifier). The output of the receive chain variable gain amplifier is connected to a second RF switch, which is similarly of a single pole, double throw type in which the pole terminal is connected to the phase shifter, the first throw terminal is connected to the transmit chain (e.g., the input of the transmit chain variable gain amplifier), and the second throw terminal is connected to the receive chain (e.g., the output of the receive chain variable gain amplifier). The phase shifters are each connected to a combiner circuit, which has a single RF signal output port. Conventionally, the combiner circuit is also a Wilkinson-type. The aforementioned splitter and such combiner circuit may be a single splitter-combiner.

The transmit chain and the receive chain may be comprised of separate and independent components aside from the shared intermediate RF switches and the splitter-combiner. However, in some cases, it is also possible for the transmit and receive chains to share certain components, for example, the phase shifter. In such implementations, one port of the phase shifter is connected to the splitter-combiner, and the other port is connected to the pole terminal of the second RF switch, and so the phase shifter may be part of separate transmit and receive chains, or a part of a common transmit-receive chain.

Current 5G mmWave phased array antenna solutions may utilize up to several hundred individual transmit and receive chains, as the total corresponds to the number of antenna elements in the array, which can be in the hundreds. Such larger configurations may be utilized for base stations, customer premise equipment (CPEs) and so forth. Each transmit chain and receive chain results in a corresponding increase in the semiconductor die area of the beamformer integrated circuit. Furthermore, each chain contributes to an undesirable increase in DC current drain from the bias supply, increase in switching speed between the transmit and receive chains, and increase in the number of control lines and associated serial peripheral interface (SPI) registers to control each of the circuits.

By virtue of the array design, the antenna elements are physically separated from each other, and so different antenna elements may receive signals with markedly different power levels due to multipath signal propagation. That is, the received signal on one antenna element may have arrived following multiple reflections from objects between the transmit node and the receive node, whereas the received signal on another antenna element may not. In some cases, signal levels at different antenna elements may vary by 10 dB or more with multi-path receive signals. As a consequence, the sensitivity of the entire receive chain may be degraded, as gain will be reduced while the noise figure will be increased. Existing phased array antenna systems are also deficient because a high power level blocking or jamming signal that is received by at least one antenna element may likewise degrade the sensitivity of the entire receive chain, even with the spacing of individual antenna elements.

Accordingly, there is a need in the art for a beamformer architecture that reduces the noise figure and improves total gain of the receive chain in mitigation against receive sensitivity degradation due to multipath effects. Furthermore, there is a need to improve blocking performance of the receive chain circuitry, so that receive sensitivity is not comprised by high level blocking/jamming signals.

### BRIEF SUMMARY

The present disclosure is directed to RF phased array antenna beamformer architectures that are contemplated to address the deficiencies in the art. The beamformer circuit may be connectible to an array of antenna elements and include one or more of splitter-combiners that may each have a combined port and one or more split ports. Additionally, the circuit may include one or more transmit/receive circuits that are each connected to a respective one of the split ports of the splitter-combiners and to a respective one of the antenna elements of the array. Each of the transmit/receive circuits may include a transmit chain and a receive chain. Gain of a given one of the receive chain may be adjustable in response to a reception signal power level through the receive chain being lower than a first predetermined threshold or higher than a second predetermined threshold.

Another embodiment of the present disclosure may be a phased array beamformer circuit that is connectible to an array of antenna elements. The circuit may include one or more of RF input/output ports, and one or more of splitter-combiners. The splitter-combiners may each include a combined port that is connected to a respective one of the one or more RF input/output ports, and one or more split ports. There may also be one or more transmit/receive circuits that may each be connected to a respective one of the split ports of the splitter-combiners and to a respective one of the antenna elements of the array. Each of the transmit/receive circuits may including a transmit chain and a receive chain. The circuit may further include power sense circuits connected to each of the receive chains of the one or more transmit/receive circuits. The power sense circuits may output reception power level signals corresponding to detected power levels of signals through given ones of the receive chains. The circuit may also include gain controllers connected to each of the receive chains of the one or more transmit/receive circuits and to a corresponding one of the power sense circuits. Respective gains of the receive chains may be adjustable based upon control signals outputted by the gain controller.

The embodiments of the present disclosure may also include a phased array beamformer circuit that is connectible to an array of antenna elements. The circuit may include a radio frequency input/output port, as well as a splitter-combiner with a combined port connected to the RF input/output port and a plurality of split ports. There may be a first transmit/receive circuit that is connected to one of the split ports of the splitter-combiner and to one of the antenna elements of the array. The first transmit/receive circuit may include a transmit chain and a receive chain. The circuit may also include a second transmit/receive circuit that is connected to another one of the split ports of the splitter-combiner and to another one of the antenna elements of the array. The second transmit/receive circuit may include a transmit chain and a receive chain. Furthermore, there may be a first power sense circuit that is connected to the receive chain of the first transmit/receive circuit. The first power sense circuit may output a first reception power level signal corresponding to a detected power level of a first signal through the receive chain of the first transmit/receive circuit. There may also be a first gain reducer that is connected to the receive chain of the first transmit/receive circuit and to the first power sense circuit. Gain of the receive chain of the first transmit/receive circuit may be reduced in response to the first reception power level signal. In addition to the gain reducer, there may be a first gain enhancer that connected to the receive chain of the second transmit/receive circuit and to the first power sense circuit. Gain of the receive chain of the second transmit/receive circuit may be increased in response to the first reception power level signal.

The beamformer circuit may also include a second power sense circuit that is connected to the receive chain of the second transmit/receive circuit. The second power sense circuit may output a second reception power level signal that corresponds to a detected power level of a second signal through the receive chain of the second transmit/receive circuit. The circuit may also include a second gain reducer that is connected to the receive chain of the second transmit/receiver chain and to the second power sense circuit. Gain of the receive chain of the second transmit/receive circuit may be reduced in response to the second reception power level signal. Further, there may be a second gain enhancer that is connected to the receive chain of the first transmit/receive circuit and to the second power sense circuit. The gain of the first transmit/receive circuit may be increased in response to the second reception power level signal.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a first embodiment of a phased array beamformer circuit with multipath mitigation and jamming resistance in accordance with the present disclosure;

FIGS. 2A-2C are schematic diagrams of a conventional splitter-combiner that may be utilized in the various embodiments of the phase array beamformer circuit of the present disclosure;

FIG. 3 is a graph plotting the received signal power loss for different numbers of receive chains in the circuit;

FIG. 4 is a schematic diagram of an implementation of a beamformer circuit;

FIG. 5A is a graph plotting the total noise figure of receive chain components in the beamformer circuit of FIG. 4 in various combinations of activated and deactivated stages;

FIG. 5B is a graph plotting the total gain of receive chain components in the beamformer circuit of FIG. 4 in various combinations of activated and deactivated stages; and

FIG. 6 is a schematic diagram of a second embodiment of a phased array beamformer circuit with multipath mitigation and jamming resistance.

### DETAILED DESCRIPTION

The present disclosure encompasses various embodiments of a radio frequency (RF) integrated circuit for phased antenna array beamformer architectures. The circuits are contemplated to reduce the overall noise figure of the receive chain and improve gain in spite of multipath signals that can otherwise result in the degradation of receive sensitivity. Additionally, the circuit is contemplated to improve blocking performance of the receive chain without compromising receive sensitivity that may be problematic with the presence of high power level jamming signals. As will be described in further detail below, various power sense circuits and gain controllers may be incorporated into the receive chain in order to deactivate certain components thereof.

The detailed description set forth below in connection with the appended drawings is intended as a description of the several presently contemplated embodiments of the RF integrated circuit and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

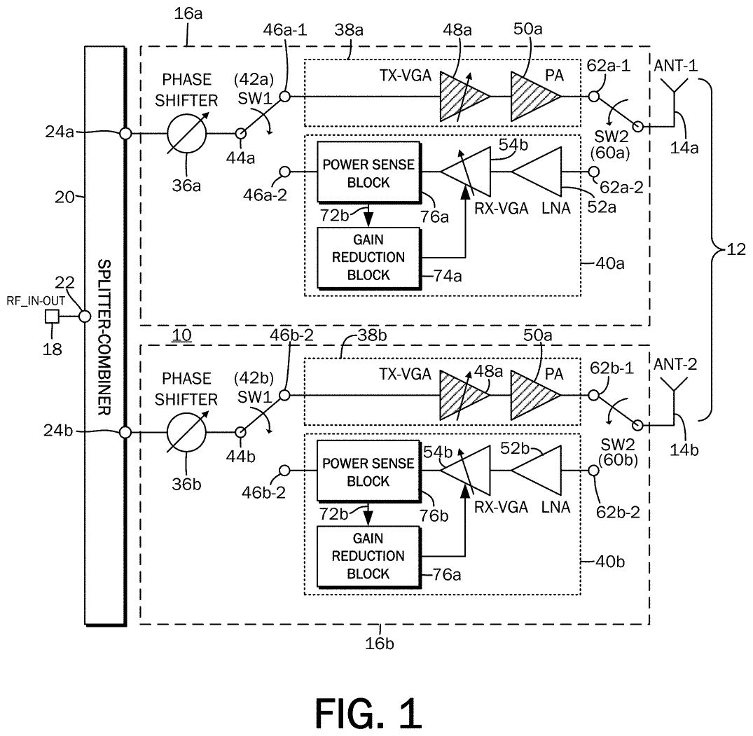

The schematic diagram of FIG. 1 illustrates a first embodiment of a phased array beamformer circuit 10, which may be part of a broader RF integrated circuit including transmitters, receivers, baseband modules, and so forth. However, this is presented by way of example only, and the phased array beamformer circuit 10 may be part of an independent module separate from the RF integrated circuit.

The illustrated phased array beamformer circuit 10 may be utilized as part of a 5G mnWave phased array antenna architecture. As understood, the 5G mobile network standard is comprised of FR1 and FR2 frequency ranges, with FR2 being commonly referred to as millimeter wave or mmWave because the operating frequency is above 24 GHz to 50 GHz. There are discrete frequency bands with defined bandwidths and may be referred to as low band or high band, e.g., 24-30 GHz as low-band and 37-44 GHz as high-band.

In the exemplary implementation, the phased array beamformer circuit 10 may be connected to an antenna array 12 comprised of multiple antenna elements 14a, 14b. The two antenna elements 14a-14b arranged in the illustrated 2×1 configuration are presented by way of example, as there may be other implementations of a phased array antenna with additional antenna elements 14. The number of antenna elements 14 is substantially reduced for purposes of simplifying the description of the various embodiments of the disclosure, and it will be recognized by those having ordinary skill in the art that a typical phased antenna array for 5G mmWave applications will incorporate many more antenna elements 14. As utilized herein, the term “connected” is utilized in the broadest sense, and refers to any connection, direct or indirect, that is made between one component and another component between which electrical communication is maintained. It is to be understood that despite referring to one component being connected to another, the possibility of another component being interposed between such connected components while maintaining electrical communication with each is not intended to be excluded.

In a phased array antenna architecture, a separate transmit signal is fed to each of the antenna elements 14 in the array 12, with some signals being phase shifted relative to another that causes constructive and destructive interference that makes beam over the air directionality possible. In this regard, a single RF transmit signal is split for the separate antenna elements 14, and as will be described in further detail below, amplified for over-the-air transmission. Likewise, the received RF signal are transduced by each of the individual antenna elements 14 and yield multiple RF receive signals, some of which may be phase shifted relative to the others. Each of the individual received signals are amplified, and the phase shifts are then reversed and combined into a single RF output signal.

The set of components of the phased array beamformer circuit 10 dedicated to a specific antenna element 14 may be referred to as a transmit/receive circuit 16, with the schematic diagram of FIG. 1 showing a first transmit/receive circuit 16a connected to the first antenna element 14a, and a second transmit/receive circuit 16b connected to the second antenna element 14b. The transmit signal is provided by the transmitter to the phased array beamformer circuit 10 via an RF input/output port 18. The received signal from the antenna array 12 is also output from the same RF input/output port 18, which may also be connected to the receiver.

The phased array beamformer circuit 10 includes a splitter-combiner 20 with a combined port 22 that is connected to the RF input/output port 18, along with split ports 24a and 24b that are connected to respective transmit/receive circuits 16a, 16b. The splitter-combiner 20 is understood to be a Wilkinson-type splitter, though any other suitable splitter circuit known in the art or subsequently developed may be utilized without departing from the scope of the present disclosure. Although the phased array beamformer circuit 10 is shown with a single RF input/output port 18 and incorporating only a single splitter-combiner 20, other configurations with multiple splitter-combiners to accommodate multiple RF input/output ports specific to 5G mmWave high band signals, low band signals, and the like are also possible. As such, other implementations of the phased array beamformer circuit 10 may have more than one RF input/output ports 18, splitter-combiners 20, transmit/receive circuits 16, and so on.

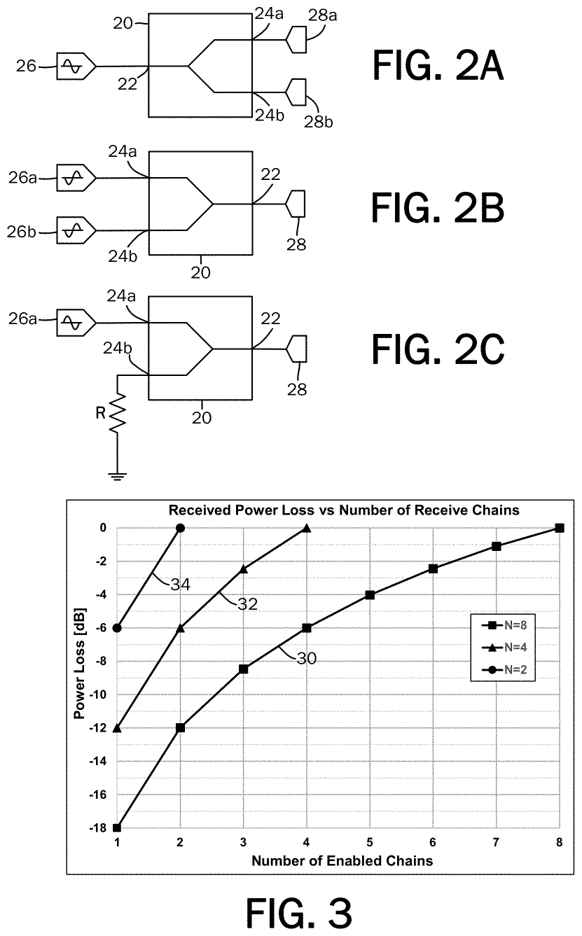

One reason for increased noise figure/reduced gain in a phased antenna array architecture resulting from disparate power levels received on one antenna element 14 versus another, such as is the case with a multipath signal reaching one antenna element 14 but not another, or a high power level blocking signal reaching one antenna element 14 but not another, is the inherent operating characteristic of the splitter-combiner 20. With reference to schematic diagrams of FIGS. 2A-2C, the splitter-combiner 20 is generally defined by the single combined port 22 and the multiple (two in the illustrated example) split ports 24a and 24b.

FIG. 2A illustrates an input signal 26 being passed to the combined port 22, which is then separated to the first split port 24a and the second split port 24b and output as a first split signal 28a and a second split signal 28b. Power may be equally or evenly split between the first split port 24a and the second split port 24b, and with an ideal splitter-combiner 20, the power level of the resultant first output signal 28a from the first split port 24a and the second output signal 28b from the second split port 24b are both reduced by 3 dB relative to the power level of the input signal 26.

FIG. 2B illustrates an example ideal splitter-combiner 20 with the first input signal 26a provided to the first split port 24a and the second input signal 26b provided to the second split port 24b have equal power levels. In such case, the power of the output signal 28 at the combined port 22 is understood to be increased by 3 dB relative to the power levels of the first and second input signals 26a, 26b. In other words, two signals with equal amplitudes applied to two split ports are arithmetically combined in power at the combined port.

Of interest to the features of the presently disclosed embodiments, FIG. 2C illustrates a first input signal 26a being provided to the first split port 24a, while no signal is being provided to the second split port 24b. In this case, the resultant output signal 28 from the combined port 22 is understood to be reduced by 3 dB. Under practical operating conditions, to the extent the input signals 26 to the split ports 24 have different power levels, there is no arithmetic power combining that occurs. For the sake of implementation correctness, even with the absence of an applied signal, the split port 24b is connected to an impedance represented by resistor R in FIG. 2C. By way of example, the resistor R may be 50-Ohm if the splitter-combiner circuit 20 is implemented as such. It will be recognized that different resistance values may be used in actual implementation.

The passive splitter-combiner 20 utilized in the phased array beamformer circuit 10 is understood to exhibit these operating characteristics, and where there are multiple receive chains, that is, multiple transmit/receive circuits 16 in a given phased array beamformer circuit 10 that is connected to a single splitter-combiner 20, losses of signal power associated with each additional receive chain may accumulate. The graph of FIG. 3 illustrates these losses for an ideal splitter-combiner. A first plot 30 is for a phased array beamformer circuit 10 with eight receive chains, and the power loss for a different number of enabled chains is shown. A second plot 32 is for a phased array beamformer circuit 10 with four receive chains, and a third plot 34 is for a phased array beamformer circuit 10 with two receive chains. Again, when all of the receive chains are enabled, power loss for a phased array beamformer circuit 10 with any number of receive chains is understood to be zero. With two receive chains but with one disabled, the power loss is approximately −6 dB. Likewise, with four receive chains but with only one enabled, the power loss is approximately −12 dB. Additional receive chains are understood to accumulate further losses, such as with eight receive chains but with only one enabled, the power loss is approximately −18 dB.

Each of the transmit/receive circuits 16a, 16b are understood to include a phase shifter 36, with the first transmit/receive circuit 16a including a first phase shifter 36a, and the second transmit/receive circuit 16b including a second phase shifter 36b. The phase shifters 36 are understood to be two-port devices with a first port being connected to a respective one of the split ports 24 of the splitter-combiner, and a second port being connected to further circuit elements.

In accordance with the illustrated embodiment of the present disclosure, one phase shifter 36 is utilized for both transmit signals and receive signals. Thus, there is a modality by which the further upstream transmit chain circuitry, also referred to as a transmit chain 38 of the transmit/receive circuit 16, is connected during transmit operations, and further downstream receive chain circuitry, also referred to as a receive chain 40 of the transmit/receive circuit 16, is connected during receive operations. Specifically, each of the transmit/receive circuits 16a, 16b further include a single pole, double throw switch 42 operated to exclusively connect either the transmit chain 38 or the receive chain 40.

The first phase shifter 36a is connected to a first splitter/combiner-side switch 42a, and the second phase shifter 36b is connected to a second splitter/combiner-side switch 42b. More particularly, the first splitter/combiner-side switch 42a has a pole terminal 44a to which the second terminal of the first phase shifter 36a is connected, and the second splitter/combiner-side switch 42b has a pole terminal 44b to which the second terminal of the second phase shifter 36b is connected. As the foregoing splitter/combiner-side switches 42a, 42b are most closely connected to the shifter-combiner 20, they will be referred to as splitter/combiner-side switches 42, and are shown in FIG. 1 labeled as SW1.

The throw terminals of a given one of the splitter/combiner-side switches 42 are connected to either the upstream transmit chain 38 or the downstream receive chain 40. In further detail, a first throw terminal 46a-1 of the first splitter/combiner-side switch 42a is connected to the first transmit chain 38a of the first transmit/receive circuit 16a, and a second throw terminal 46a-2 of the first splitter/combiner-side switch 42a is connected to the first receive chain 40a of the first transmit/receive circuit 16a. Similarly, a first throw terminal 46b-1 of the second splitter/combiner-side switch 42b is connected to the second transmit chain 38b of the second transmit/receive circuit 16b, and a second throw terminal 46b-2 of the second splitter/combiner-side switch 42b is connected to the second receive chain 40b of the second transmit/receive circuit 16b.

The upstream transmit chain 38 may be comprised of a variable gain power amplifier 48, which in turn may be connected in series with a power amplifier 50. Thus, the transmit chain 38a of the first transmit/receive circuit 16a includes a first variable gain power amplifier 48a and a first power amplifier 50a, with the input to the first variable gain power amplifier 48a being connected to the first throw terminal 46a-1 of the first splitter/combiner-side switch 42a. The transmit chain 38b of the second transmit/receive circuit 16b similarly includes a second variable gain power amplifier 48b and a second power amplifier 50b, with the input to the second variable gain power amplifier 48b being connected to the first throw terminal 46b-1 of the second splitter/combiner-side switch 42b. Although FIG. 1 presents a common phase shifter in each transmit/receive chain, alternative antenna beamformer architectures may have separate transmit and receive chain phase shifters.

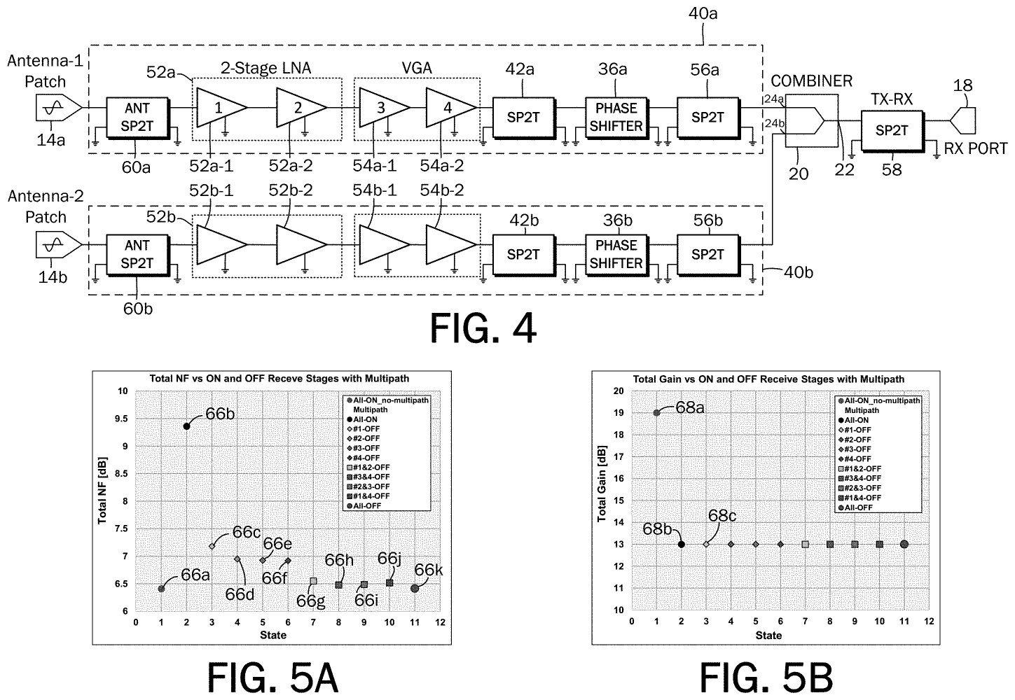

The schematic diagram of FIG. 4 is an equivalent representation of certain parts of the receive chains 40a, 40b, together with selected shared components such as the splitter-combiner 20, the phase shifters 36a, 36b, and the splitter/combiner-side switches 42a, 42b discussed above. These are being presented to illustrate simulated gain decreases and noise figure increases, which embodiments of the present disclosure are contemplated to mitigate. With concurrent reference to the schematic diagram of FIG. 1, the receive chains 40 may each include a low noise amplifier 52, which in turn is connected in series with variable gain low noise amplifiers 54. Thus, the first receive chain 40a includes a first low noise amplifier 52a and a first variable gain low noise amplifier 54a, while the second receive chain 40b includes a second low noise amplifier 52b and a second variable gain low noise amplifier 54b. In further detail as shown in FIG. 4, the first low noise amplifier 52a may be implemented as multiple stages, including a first amplification stage 52a-1 and a second amplification stage 52a-2. The second low noise amplifier 52b of the receive chain 40b may likewise be implemented as multiple stages in a first amplification stage 52b-1 and a second amplification stage 52b-2.

The variable gain low noise amplifiers 54 may likewise be implemented as multiple stages. The first variable gain low noise amplifier 54a may include a first amplification stage 54a-1 and a second amplification stage 54a-2, and the second variable gain low noise amplifier 54b may include a first amplification stage 54b-1 and a second amplification stage 54b-2. The output from the variable gain low noise amplifiers 54 are connected to the second throw terminals of the splitter/combiner-side switches 42. For the first receive chain 40a, the output of the second amplification stage 54a-2 of the first variable gain low noise amplifier 54a is connected to the second throw terminal 46a-2 of the first splitter/combiner-side switch 42a. For the second receive chain 40b, the output of the second amplification stage 54b-2 of the second variable gain low noise amplifier 54b is connected to the second throw terminal 46b-2 of the second splitter/combiner-side switch 42b. Additional components may interconnect the throw terminals 46 to the variable gain low noise amplifiers 54 in accordance with the embodiments of the present disclosure, so such connections may be indirect despite being shown otherwise in the schematic diagram of FIG. 4.

Although not shown in the schematic diagram of FIG. 4, upstream of the phase shifter 36a in the context of the receive chain, there may be an additional single pole, double throw switch 56 before the connection to the splitter-combiner 20. In this regard, the first receive chain 40a may include a single pole, double throw switch 56a, and the second receive chain 40b may include another single pole, double throw switch 56b. The combined port 22 of the splitter-combiner 20 may also be selectively connected to the RF input/output port 18 via yet another single pole, double throw switch 58 to the extent a circuit implementation utilizes dedicated receive output and transmit input ports.

As indicated above, each of the transmit/receive circuits 16 are connected to individual antenna elements 14 of the antenna array 12. Time division multiple access modalities are the contemplated applications for the exemplary embodiments of the phased array beamformer circuit 10, so transmit and receive operations do not occur simultaneously for any given antenna element 14. Thus, the transmit chain 38 and the receive chains 40 are selectively connected to the antenna elements 14 with another single pole, double throw switch 60. As this switch is connected to the antenna elements 14, they will be referred to as antenna-side switches that are shown in FIG. 1 labeled as SW2.

In the first transmit/receive circuit 16a, the first transmit chain 38a, and more specifically, the output of the first power amplifier 50a, is connected to a first throw terminal 62a-1 of the first antenna-side switch 60a. Furthermore, the first receive chain 40a, and specifically the input of the first low noise amplifier 52a, is connected to a second throw terminal 62a-2 of the first antenna-side switch 60a. A pole terminal 64a is connected to the first antenna element 14a. There is a corresponding second antenna-side switch 60b for the second transmit/receive circuit 16b, which selectively connects the second transmit chain 38b and the second receive chain 40b thereof to the second antenna element 14b. More particularly, the output of the second power amplifier 50b is connected to a first throw terminal 62b-1 of the second antenna-side switch 60b, and the input to the second low noise amplifier 52b is connected to a second throw terminal 62b-2.

The antenna-side switches 60 and the splitter/combiner-side switches 42 are concurrently switched in coordination with each other, so that either the circuit corresponding to the transmit chains or the receive chains is completed between phase shifter 36 and the antenna element 14. The architecture of the transmit/receive circuits 16, including the use of the splitter-combiner 20, the phase shifters 36, and so forth constitutes one implementation, and any other suitable architecture may be substituted without departing from the scope of the present disclosure.

Referring additionally now to the schematic diagram of FIG. 4, each of the foregoing components of the transmit/receive circuits 16a, 16b are understood to have associated losses that impact the performance of the overall circuit. By way of example, each of the amplification stages in a given receive chain 40, e.g., for the first receive chain 40a, the first amplification stage 52a-1 and the second amplification stage 52a-2 comprising the first low noise amplifier 52a, and the first amplification stage 54a-1 and the second amplification stage 54a-2 comprising the first variable gain low noise amplifier 54a, and for the second receive chain 40b, the first amplification stage 52b-1 and the second amplification stage 52b-2 comprising the second low noise amplifier 52b, and the first amplification stage 54b-1 and the second amplification stage 54b-2 comprising the second variable gain low noise amplifier 54b, may be configured with a gain of 9 dB and a noise figure of 4 dB. Each of the single pole, double throw switches, including the antenna-side switches 60a, 60b and the splitter/combiner-side switches 42a, 42b, as well as the single pole, double throw switches 56a, 56b before the connection to the splitter-combiner 20, are understood to have an insertion loss of 2 dB. The phase shifters 36a, 36b may have a 12 dB insertion loss, as each stage in a 6-bit phase shifter may have a 2 dB insertion loss. It will be recognized by those having ordinary skill in the art that the foregoing gain and loss parameters are typical for complementary metal oxide semiconductor (CMOS)-implemented phased antenna array beam former circuits at millimeter wave frequencies, that is, up to 90 GHz.

With a 2×1 antenna array as depicted in the schematic diagram of FIG. 4, without additional mitigation measures, the second receive chain 40b may introduce additional noise power at the second split port 24b of the splitter-combiner 20. As such, the noise figure of the entire receive chain of the phased array beamformer circuit 10 may be degraded by 3 dB relative to an operation in which both the first receive chain 40a and the second receive chain 40b are activated and passing receive signals of equal power. This noise figure degradation may occur when, for example, the first receive chain 40a passes a receive signal of adequate power level to the first split port 24a, while the second receive chain 40b does not pass a usable signal, such as would be the case for a receive signal with reduced power because of multipath propagation phenomena. Further, the gain of the entire receive chain is reduced by 6 dB due to the operational principles of the passive splitter-combiner 20 as discussed above. The noise figure of the entire receive chain may also be increased as a result of the noise contribution from receive chains amplifying noise. The cumulative impact of these degradations in the receive chain, including the cascading impact to the down-conversion chain and the baseband chain, is the dramatic reduction in overall receiver sensitivity.

Continuing with the example of the simulated circuit shown in FIG. 4, where only one of the receive chains (e.g., the first receive chain 40a) passes a receive signal from the first antenna element 14a to the RF input/output port 18 though the second receive chain 40b remains enabled, the entirety noise therefrom is passed to the second split port 24b. This is understood to increase the noise figure of the entire receive chain to 9.4 dB, with a gain of 13 dB. In accordance with the embodiments of the present disclosure, the unused receive chain 40b may also be deactivated, and only a 50 Ohm thermal noise is present at the second split port 24b. In such case, the gain is similarly 13 dB, but the noise figure is 6.4 dB. In contrast, where both the first receive chain 40a and the second receive chain 40b are passing usable signals at similar power levels, the gain of the receive chain may be 16 dB, or 19 dB referenced to a single antenna element 14, and the noise figure may be 6.4 dB.

The graphs of FIGS. 5A and 5B plot the total noise figure and gain, respectively, of the simulated circuit of FIG. 4, with the data points representing various operating states. One plot point 66a on the noise figure graph of 5A and one plot point 68a on the gain graph of FIG. 5B correspond to an operating mode in which the first receive chain 40a and the second receive chain 40b are both active, and without a multi-path signal. This is the ideal operating condition, where the noise figure is minimized while gain is maximized. The remaining plot points are for operating modes with different amplification stages being activated and deactivated while a multipath signal is being received. As a general matter, whenever a multipath signal is being received, the noise figure of the entire receive chain is degraded by at least 3 dB, and the gain is decreased by at least 6 dB. A plot point 66b and a plot point 68b are of the noise figure and gain of the overall receive chain when all of the amplification stages are active, with a multipath signal being received. This represents the worst-case condition, where the noise figure is at a maximum and the gain is reduced to 13 dB.

According to various embodiments of the present disclosure, deactivating one or more of the amplification stages can yield improvements in the overall noise figure and gain. A plot point 66c and a plot point 68c are of the first amplification stage 52a-1 of the first low noise amplifier 52a being deactivated, which reduces the overall noise figure to 7.18 dB, while overall gain remains at 13 dB. This reduction in gain is expected to be the same over all permutations of amplification stage deactivations. A plot point 66d corresponds to the second amplification stage 52a-2 of the first low noise amplifier 52a being deactivated, with the overall noise figure further reduced to 6.95 dB. The overall noise figure of 6.925 dB resulting from the deactivation of the first amplification stage 54a-1 of the first variable gain low noise amplifier 54a is shown in a plot point 66e, while the overall noise figure of 6.92 dB resulting from the deactivation of the second amplification stage 54a-2 of the first variable gain low noise amplifier 54a is shown in a plot point 66f.

Deactivation of multiple amplification stages can yield a further reduction in the overall noise figure. For purposes of the simulation results, a deactivated amplification stage is understood to refer to a gain of 0 dB and a noise figure of 4 dB, though actual implementations may vary depending on the configuration of the amplifiers. A plot point 66g corresponds to the entirety of the first low noise amplifier 52a, that is, the first amplification stage 52a-1 and the second amplification stage 52a-2 thereof being deactivated. The overall noise figure in such case is understood to be 6.552 dB. A plot point 66h corresponds to the entirety of the first variable gain low noise amplifier 54a, that is, the first amplification stage 54a-1 and the second amplification stage 54a-2 thereof being deactivated. The overall noise figure under such conditions may be 6.479 dB.

Selected amplification stages spanning both the low noise amplifier 52 and the variable gain low noise amplifier 54 may be deactivated as well. A plot point 66i corresponds to the second amplification stage 52a-2 of the first low noise amplifier 52a being deactivated, and the first amplification stage 54a-1 of the first variable gain low noise amplifier 54a being deactivated. The overall noise figure in this combination of amplification stage deactivations may be 6.487 dB. Along the same lines, the first amplification stage 52a-1 of the first low noise amplifier 52a and the second amplification stage 54a-2 of the first variable gain low noise amplifier 54a may be deactivated. A plot point 66j corresponds to this condition, and the overall noise figure is understood to be 6.515 dB. A plot point 66k corresponds to all amplification stages being deactivated, resulting in an overall noise figure of 6.414 dB. Thus, the foregoing illustrates that deactivating just one of the amplification stages may result in a noise figure reduction of at least 2.5 dB and deactivating more than one amplification stage may result in an overall noise figure reduction of an additional 0.5 dB.

The foregoing examples were in the context of a 2×1 antenna array, and it will be appreciated that the noise figure and gain degradations attributable to multipath signals remain with larger antenna arrays. In a 4×1 antenna array, if one of the receive chains is receiving a multipath signal with a significantly reduced power level, such as, for example, 10 dB lower than the other three receive chains, the gain of the overall receive chain may be reduced by 1.25 dB as well as a noise figure degradation of 1.25 dB relative to a circuit operating without receiving a multipath signal. A similar mitigation effort taken along the lines of those described above, e.g., deactivating the second amplification stage variable gain amplifier, the noise figure degradation may be limited to 0.18 dB.

If two receive chains simultaneously receive a multipath signal with a low power level in a 4×1 antenna array, the gain of the overall receive chain may be reduced by 3 dB, and the noise figure may be increased by 3 dB. The same mitigation effort of deactivating the variable gain amplifiers in the receive chains with low power level multipath signals thereon is understood to reduce the noise figure degradation to 0.55 dB. Deactivating just the second amplification stage of the variable gain amplifiers may limit the noise figure degradation to 1.95 dB rather than 3 dB as would be the case if all of the variable gain amplifiers remained activated. Deactivating both the first and second amplification stages of the variable gain amplifiers in the receive chains with the lower power level multipath signal results in an overall noise figure degradation of 0.1 dB relative to the ideal condition of all of the receive chains being activated with no multipath signal.

If three of the four receive chains simultaneously receive a multipath signal with a low power level, more severe receive chain performance degradation can be expected. Again, applying the same mitigation techniques as above and deactivating the impacted receive chains is contemplated to significantly reduce the noise figure of the entire receive chain. As can be seen, a phased array beamformer circuit, regardless of the specific architecture or the number of transmit/receive chains, are prone to receive sensitivity degradation because of potentially low power level signals receive on some of the antenna elements 14. The embodiments of the present disclosure therefore contemplate the detecting of signals with significantly lower power levels, with a threshold therefor being defined. The amplification stages may be deactivated based on whether the received signal on a given one of the receive chains is lower than such threshold, which is envisioned to decrease the noise figure degradation over the entire receive chain.

Referring again to the schematic diagram of FIG. 1, the first receive chain 40a additionally includes a first power sense circuit or block 70a that is connected to the output of the first variable gain low noise amplifier 54a. The incoming RF signal as received by the first antenna element 14a and amplified by the first low noise amplifier 52a and the first variable gain low noise amplifier 54a is detected by the first power sense block 70a. The detection/evaluation of the receive signal may be based upon the RF signal level, the direct current (DC) current level, or the DC voltage level.

If the power level of the receive signal being passed through the first receive chain 40a is lower than a predefined low threshold, the embodiments of the present disclosure contemplate deactivating the first variable gain low noise amplifier 54a or other receive chain amplifier circuits or reducing the gain(s) thereof. This condition is understood to be correlated to receiving a multipath signal. The threshold value of the power level of the incoming signal may be adjusted as necessary. The first power sense block 70a outputs a reception power level signal 72a to a first gain reduction block 74a, which in turn is connected to the first variable gain low noise amplifier 54a.

In response to the reception power level signal 72a, the first gain reduction block 74a may output a control signal 76a to the first variable gain low noise amplifier 54a to deactivate or reduce the gain of the same. When reducing the gain of the receive chain, it may be set to at least 10 dB lower than the gain of the entire receive chain. In so reducing the gain or deactivating the receive chain 40a entirely, the noise power at the split port 24a of the splitter-combiner 20 is reduced, and the entire receive chain noise figure is reduced while increasing its sensitivity despite the presence of the multipath signal.

Alternatively, if the power level of the receive signal being passed through the first receive chain 40 is higher than a predefined upper threshold, the present disclosure also contemplates reducing the gain of the first variable gain low noise amplifier 54a or other receive chain amplifier circuits. This condition may be correlated to receiving large blocking or jamming signal at the first antenna element 14a. Again, the first power sense block 70a outputs a reception power level signal 72a to the first gain reduction block 74a that outputs the control signal 76a to the first variable gain low noise amplifier 54a to reduce the gain thereof or deactivate the first variable gain low noise amplifier 54a entirely. The first gain reduction block 74a may output another control signal 76a to the first variable gain low noise amplifier 54a to reduce the gain thereof, and according to a preferred, though optional embodiment, the reduced gain may be set to at least 10 dB lower than the gain of the entire receive chain. As such, the noise power of the blocking signal at the split port 24a of the splitter-combiner 20 is reduced, and the entire receive chain noise figure is reduced while increasing its sensitivity despite the blocking or jamming signal.

The second receive chain 40b similarly includes a second power sense circuit or block 70b that is connected to the output of the second variable gain low noise amplifier 54b. The incoming signal received by the second antenna element 14b, which is then amplified by the second low noise amplifier 52b and the second variable gain low noise amplifier 54b, is detected by the second power sense block 70b. Like the first receive chain 40a, the second receive chain 40b includes a second gain reduction block 74b that is connected to the second power sense block 70b. The second gain reduction block 74b reduces the gain or deactivates the corresponding second variable gain low noise amplifier 54b in response to a reception power level signal 72b output from the second power sense block 70b. The functionality and features of the second power sense block 70b and the second gain reduction block 74b are otherwise identical to the first power sense block 70a and the first gain reduction block 74a, and so they will not be repeated for the sake of brevity.

The illustrated configuration of the power sense blocks 70 show the output of the variable gain low noise amplifiers 54 being connected thereto, and as described above, the power level of the receive signal amplified by the low noise amplifiers 52 and the variable gain low noise amplifiers 54 is detected. This configuration is exemplary only, however, and the power sense blocks 70 may be connected anywhere else along the respective receive chains 40 without departing from the scope of the disclosure. Furthermore, the configuration of the gain reduction blocks 74 controlling the gain of the variable gain low noise amplifiers 54 is likewise exemplary, and the gain reduction blocks 74 may additionally control the low noise amplifiers 52. Along these lines, while the gain reduction blocks 74 may be referenced as such in the present disclosure, it may be configured to generally control the gain rather than be limited to reducing the gain. The gain reduction blocks 74 may therefore be generally referred to as gain controllers or a gain control blocks.

The schematic diagram shows only two antenna elements 14a, 14b connecting to corresponding transmit/receive circuits 16a, 16b, but as indicated above, there may be additional antenna elements 14 and transmit/receive circuits 16. The configuration of the transmit/receive circuits 16 discussed above, including the power sense blocks 70 and the gain reduction blocks 74, may be replicated in such additional transmit/receive circuits 16. From the described functionality of the power sense blocks 70 and the gain reduction blocks 74, the specific implementations thereof are deemed to be within the purview of those having ordinary skill in the art. Different semiconductor technologies may be used to fabricate single-die implementations of the first embodiment of the phased array beamformer circuit 10a.

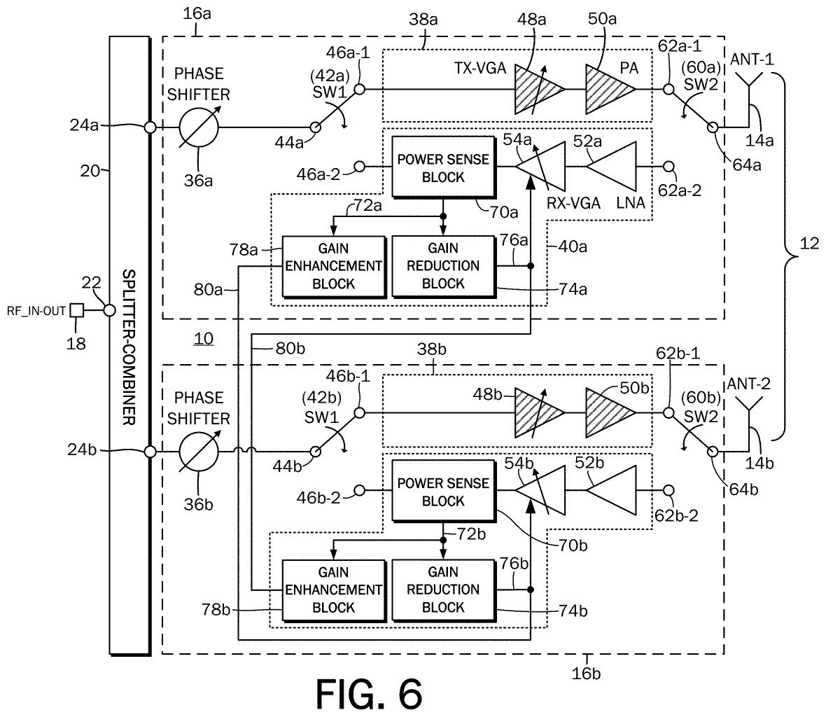

FIG. 6 illustrates a second embodiment of the phased array beamformer circuit 10, which shares many commonalities with the first embodiment. Again, the phased array beamformer circuit 10 may be utilized as part of a 5G mmWave phased array antenna architecture and may be connected to the antenna array 12 comprised of the multiple antenna elements 14a, 14b. Although a 2×1 configuration is shown, it will be recognized that other phased array antenna configurations with additional antenna elements 14 may be substituted. Each antenna element 14 is connected to a separate transmit/receive circuit 16: the first antenna element 14a is connected to and associated with the first transmit/receive circuit 16a, and the second antenna element 14b is connected to an associated with the second transmit/receive circuit 16b. The transmit signal is provided by an external transmitter to the phased array beamformer circuit 10 over the RF input/output port 18. The received signal from the antenna array 12 is also output from the same RF input/output port 18, which may also be connected to an external receiver. The splitter-combiner 20 is the modality by which this functionality is implemented, with the combined port 22 connected to the RF input/output port 18 and the first and second split ports 24a, 24b connected to the respective first and second transmit/receive circuits 16a, 16b.

Generally, the transmit/receive circuits 16 are comprised of the transmit chain 38 and the receive chain 40. The first transmit/receive circuit 16a thus includes the first transmit chain 38a with the first variable gain power amplifier 48a that is connected in series with the first power amplifier 50a. Similarly, the second transmit/receive circuit 16b includes the second transmit chain 38b with the second variable gain power amplifier 48b and the second power amplifier 50b. The receive chains 40 are configured differently than the first embodiment of the phased array beamformer circuit 10, the details of which will be described more fully below. There is some overlap, however, in the same low noise amplifiers 52 and the variable gain low noise amplifiers 54. Specifically, the first transmit/receive circuit 16a incorporates the first low noise amplifier 52a that is connected in series with the first variable gain low noise amplifier 54a. The second transmit/receive circuit 16b includes the second low noise amplifier 52b connected in series with the second variable gain low noise amplifier 54b.

In addition to the same transmit chains 38 and the similar receive chains 40, the transmit/receive circuits 16 include the same phase shifters 36. The first transmit/receive circuit 16a includes the first phase shifter 36a with a first port connected to the first split port 24a of the splitter-combiner 20 and a second port selectively connectible to either the first transmit chain 38a or the first receive chain 40a. This selective connection may be established by the first splitter/combiner-side switch 42a. Likewise, the second transmit/receive circuit 16b includes the second phase shifter 36b with its first port connected to the second split port 24b and the second port selectively connectible to either the second transmit chain 38b or the second receive chain 40b. The second splitter/combiner-side switch 42b is thus provided.

The second throw terminals of the splitter/combiner-side switches 42 are connected to respective receive chains 40 of the transmit/receive circuits 16. In the first transmit/receive circuit 16a, this is the first receive chain 40a, while in the second transmit/receive circuit 16b, this is the second receive chain 40b. Although the low noise amplifiers 52 and the variable gain low noise amplifiers 54 are similarly configured, gain control may be achieved with a different modality in comparison to the first embodiment of the receive chains 40 discussed above. Additional details thereof will be described more fully below, following the consideration of the other common features shared by both embodiments of the transmit/receive circuits 16.

In the first transmit/receive circuit 16a, the first phase shifter 36a is connected to the pole terminal 44a of the first splitter/combiner-side switch 42a, while in the second transmit/receive circuit 16b, the second phase shifter 36b is connected to the pole terminal 44b of the second splitter/combiner-side switch 42b. The first throw terminal 46a-1 of the first splitter/combiner-side switch 42a is connected to the input of the first variable gain power amplifier 48a (i.e., the first transmit chain 38a of the first transmit/receive circuit 16a), and the first throw terminal 46b-1 of the second splitter/combiner-side switch 42b is connected to the input of the second variable gain power amplifier 48b (i.e., second transmit chain 38b of the second transmit/receive circuit 16b). In both transmit chains 38 and the receive chains 40, the respective variable gain power amplifiers 48 are connected to corresponding power amplifiers 50. That is, the transmit chain 38a of the first transmit/receive circuit 16a includes the first power amplifier 50a, while the transmit chain 38b of the second transmit/receive circuit 16b includes the second power amplifier 50b.

The transmit chains 38 and the receive chains 40 are selectively connected to the respective antenna elements 14 with the antenna-side switches 60. The first transmit chain 38a (the output of the first power amplifier 50a) is connected to the first throw terminal 62a-1 of the first antenna-side switch 60a, while the first receive chain 40a is connected to the second throw terminal 62a-2 of the first antenna-side switch 60a. The pole terminal 64a of the first antenna-side switch 60a is connected to the first antenna element 14a. Likewise, the second transmit chain 38b (the output of the second power amplifier 50b) is connected to the first throw terminal 62b-1 of the second antenna-side switch 60b, while the second receive chain 40b is connected to the second throw terminal 6b-2 of the second antenna-side switch 60b. The pole terminal 64b of the second antenna-side switch 60b is in turn connected to the second antenna element 14b.

The antenna-side switches 60 and the splitter/combiner-side switches 42 are concurrently switched in coordination with each other, so that either the circuit corresponding to the transmit chains or the receive chains is completed between phase shifter 36 and the antenna element 14.

As indicated above, the second throw terminals of the splitter/combiner-side switches 42 are connected to respective receive chains 40 of the transmit/receive circuits 16. The outputs of the power sense blocks 70 are each connected to the respective second throw terminals of the splitter/combiner-side switches 42—for the first receive chain 40a, this is the second throw terminal 46a-2 of the first splitter/combiner-side switch 42a, and for the second receive chain 40b, this is the second throw terminal 46b-2 of the second splitter/combiner-side switch 42b.

The input to the power sense blocks 70 are connected to the outputs of the variable gain low noise amplifiers 54. In the first receive chain 40a, the output of the first variable gain low noise amplifier 54a is connected to the first power sense block 70a, and in the second receive chain 40b, the output of the second variable gain low noise amplifier 54b is connected to the second power sense block 70b. The incoming RF signal as received by the first antenna element 14a and amplified by the first low noise amplifier 52a and the first variable gain low noise amplifier 54a is detected by the first power sense block 70a, while the incoming RF signal as received by the second antenna element 14b and amplified by the second low noise amplifier 52b and the second variable gain low noise amplifier 54b is detected by the second power sense block 70b. Again, the detection/evaluation of the receive signals may be based upon the RF signal level, the direct current (DC) current level, or the DC voltage level.

If the power level of the receive signal being passed through the first receive chain 40a is lower than a predefined low threshold (e.g., when a multipath signal is being received), the embodiments of the present disclosure contemplate deactivating the first variable gain low noise amplifier 54a or other receive chain amplifier circuits or reducing the gain(s) thereof. Additionally contemplated is increasing/enhancing the gain of the other receive chain(s) not affected by a multipath signal. By way of illustrative example, this may be the second receive chain 40b, and specifically the second variable gain low noise amplifier 54b thereof. Accordingly, the second embodiment of the phased array beamformer circuit 10 includes a gain enhancement block 78, also referred to as a gain enhancer. Collectively, the gain enhancer and the gain reducer may be referred to as a gain controller or gain control block 80. Both the receive chain 40a of the first transmit/receive circuit 16a and the receive chain 40b of the second transmit/receive circuit 16b is understood to incorporate such a gain enhancer, and so there may be a first gain enhancement block 78a and a second gain enhancement block 78b.

The first power sense block 70a outputs the reception power level signal 72a to the first gain reduction block 74a and the first gain enhancement block 78a. The first gain reduction block 74a is connected to the first variable gain low noise amplifier 54a that is associated with the first receive chain 40a. The first gain enhancement block 78a is connected to the second variable gain low noise amplifier 54b, which is associated with the second receive chain 40b. To the extent there are additional receive chains 40 that are not receiving low power level signals, the first gain enhancement block 78a may increase the gain(s) of the variable gain low noise amplifiers of such receive chains.

In response to the reception power level signal 72a, the first gain reduction block 74a may output a control signal 76a to the first variable gain low noise amplifier 54a to deactivate or reduce the gain of the same. When reducing the gain of the receive chain, it may be set to at least 10 dB lower than the gain of the entire receive chain. Further in response to the reception power level signal 72a, the first gain enhancement block 78a may output another control signal 80a to the second variable gain low noise amplifier 54b to increase the gain thereof. In so reducing the gain or deactivating the receive chain 40a entirely, while simultaneously increasing the gain of the receive chain 40b, the noise power at the split port 24a of the splitter-combiner 20 is reduced, and the entire receive chain noise figure is reduced while increasing its sensitivity despite the presence of the multipath signal. The increases gain of the receive chain 40b is contemplated to completely or partially compensate for the reduction in gain of the receive chain 40a on which there is the multipath signal.

The second receive chain 40b is similarly configured, with the second power sense block 70b outputting a reception power level signal 72b to the second gain reduction block 74b and the second gain enhancement block 78b in response thereto. When the power level of the receive signal being passed through the second receive chain 40b is lower than the predefined threshold (e.g., when a multipath signal is present), the second gain reduction block 74b outputs the control signal 76b to the second variable gain low noise amplifier 54b to deactivate or reduce the gain of the same. Concurrently in response to the reception power level signal 72b, the second gain enhancement block 78b outputs another control signal 80b to the other receive chain 40a, and specifically the first variable gain low noise amplifier 54a thereof.

Mitigation against high power level blocking or jamming signals are contemplated for the second embodiment of the phased array beamformer circuit 10. If the power level of the receive signal being passed through the first receive chain 40a is higher than a predefined upper threshold, reducing the gain of the first variable gain low noise amplifier 54a, while increasing the gain of the other, non-affected second variable gain low noise amplifier 54b is contemplated. This condition may be correlated to receiving large blocking or jamming signal at the first antenna element 14a. Again, the first power sense block 70a outputs the reception power level signal 72a to the first gain reduction block 74a, which in turn outputs the control signal 76a to the first variable gain low noise amplifier 54a to reduce the gain thereof or deactivate the first variable gain low noise amplifier 54a entirely. The first power sense block 70a outputs the reception power level signal 72a to the first gain enhancement block 78a, which in turn outputs the control signal 80a to the second variable gain low noise amplifier 54b to enhance or increase the gain of the second receive chain 40b. Again, according to a preferred, though optional embodiment, the reduced gain may be set to at least 10 dB lower than the gain of the entire receive chain. As such, the noise power of the blocking signal at the split port 24a of the splitter-combiner 20 is reduced, and the entire receive chain noise figure is reduced while increasing its sensitivity despite the blocking or jamming signal.

Similarly, if the power level of the receive signal being passed through the second receive chain 40b is higher than a predefined upper threshold, reducing the gain of the second variable gain low noise amplifier 54b, while increasing the gain of the other, non-affected first variable gain low noise amplifier 54a of the first receive chain 40a is contemplated. The second power sense block 70b outputs the reception power level signal 72b to the second gain reduction block 74b, which in turn outputs the control signal 76b to the second variable gain low noise amplifier 54b to reduce the gain thereof or deactivate the variable gain low noise amplifier 5ba entirely. The second power sense block 70b outputs the reception power level signal 72b to the second gain enhancement block 78b, which in turn outputs the control signal 80b to the first variable gain low noise amplifier 54a to enhance or increase the gain of the first receive chain 40a.

Like the first embodiment, the power sense blocks 70 may be connected anywhere else along the respective receive chains 40 without departing from the scope of the disclosure. Furthermore, the configuration of the gain reduction blocks 74 or the gain enhancement blocks controlling the gain of the variable gain low noise amplifiers 54 is likewise exemplary, as such blocks may additionally control the low noise amplifiers 52. Although the schematic diagram of FIG. 6 shows only two antenna elements 14a, 14b connecting to corresponding transmit/receive circuits 16a, 16b, there may be additional antenna elements 14 and transmit/receive circuits 16. The configuration of the transmit/receive circuits 16 discussed above, including the power sense blocks 70, the gain reduction blocks 74, and the gain enhancement blocks 78, may be replicated in such additional transmit/receive circuits 16. From the described functionality of the power sense blocks 70, the gain reduction blocks 74, and the gain enhancement blocks 78, the specific implementations thereof are deemed to be within the purview of those having ordinary skill in the art. Different semiconductor technologies may be used to fabricate single-die implementations of the second embodiment of the phased array beamformer circuit 10b.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A phased array beamformer circuit connectible to an array of antenna elements, the circuit comprising:
one or more of radio frequency (RF) input/output ports;
one or more of splitter-combiners each including a combined port connected to a respective one of the one or more RF input/output ports, and one or more split ports;
one or more transmit/receive circuits each connected to a respective one of the split ports of the splitter-combiners and to a respective one of the antenna elements of the array, each of the transmit/receive circuits including a transmit chain and a receive chain;
power sense circuits connected to each of the receive chains of the one or more transmit/receive circuits, the power sense circuits outputting reception power level signals corresponding to detected power levels of signals through given ones of the receive chains; and
gain controllers connected to each of the receive chains of the one or more transmit/receive circuits, and a corresponding one of the power sense circuits, respective gains of the receive chains being adjustable based upon control signals outputted by the gain controller.

2. The circuit of claim 1, wherein the reception power level signal is generated in response to the corresponding detected power level of the signal through the given one of the receive chains being below a predetermined lower threshold.

3. The circuit of claim 2, wherein detection of the power levels of the signals is based upon an evaluation of a signal measure selected from a group consisting of: an RF signal level, a direct current (DC) current level, and a DC voltage level.

4. The circuit of claim 1, wherein the reception power level signal is generated in response to the corresponding detected power level of the signal through the given one of the receive chains being above a predetermined upper threshold.

5. The circuit of claim 1, wherein a given one of the control signals is generated by the corresponding one of the gain controllers in response to the reception power level signal from the power sense circuit connected thereto.

6. The circuit of claim 1, further comprising:
first RF switches each selectively connecting the transmit chain and the receive chain of a given one of the transmit/receive circuits to a corresponding one of the split ports; and
second RF switches each selectively connecting the transmit chain and the receive chain of the given one of the transmit/receive circuits to a corresponding one of the antenna elements.

7. The circuit of claim 1, wherein the receive chain of the transmit/receive circuits includes a low noise amplifier and a variable gain amplifier.

8. The circuit of claim 7, wherein the gain controller is connected to the variable gain amplifier, gain of the variable gain amplifier being reduced in response to the reception power level signal.

9. The circuit of claim 8, wherein the gain reduction is at least 10 dB lower than gain of the receive chain of the transmit/receive circuit.

10. The circuit of claim 8, wherein the gain reduction is achieved with a deactivation of the receive chain of the transmit/receive circuit.

11. The circuit of claim 7, wherein an input of the power sense circuit is connected to an output of the variable gain amplifier.

12. The circuit of claim 7, wherein the gain controller is connected to the low noise amplifier, gain of the low noise amplifier being reduced in response to the reception power level signal.

13. The circuit of claim 1, wherein a first one of the gain controllers decreases gain of a receive chain of a first one of the transmit/receive circuits and increases gain of one or more receive chains of other transmit/receive circuits.

14. A phased array beamformer circuit connectible to an array of antenna elements, the circuit comprising:
an RF input/output port;
a splitter-combiner including a combined port connected to the RF input/output port, and a plurality of split ports;
a first transmit/receive circuit connected to one of the split ports of the splitter-combiner and to one of the antenna elements of the array, the first transmit/receive circuit including a transmit chain and a receive chain;
a second transmit/receive circuit connected to another one of the split ports of the splitter-combiner and to another one of the antenna elements of the array, the second transmit/receive circuit including a transmit chain and a receive chain;
a first power sense circuit connected to the receive chain of the first transmit/receive circuit, the first power sense circuit outputting a first reception power level signal corresponding to a detected power level of a first signal through the receive chain of the first transmit/receive circuit;
a first gain reducer connected to the receive chain of the first transmit/receive circuit and to the first power sense circuit, gain of the receive chain of the first transmit/receive circuit being reduced in response to the first reception power level signal; and
a first gain enhancer connected to the receive chain of the second transmit/receive circuit and to the first power sense circuit, gain of the receive chain of the second transmit/receive circuit being increased in response to the first reception power level signal.

15. The circuit of claim 14, further comprising:
a second power sense circuit connected to the receive chain of the second transmit/receive circuit, the second power sense circuit outputting a second reception power level signal corresponding to a detected power level of a second signal through the receive chain of the second transmit/receive circuit;
a second gain reducer connected to the receive chain of the second transmit/receiver chain and to the second power sense circuit, gain of the receive chain of the second transmit/receive circuit being reduced in response to the second reception power level signal; and
a second gain enhancer connected to the receive chain of the first transmit/receive circuit and to the second power sense circuit, the gain of the first transmit/receive circuit being increased in response to the second reception power level signal.

16. The circuit of claim 15, wherein the first reception power level signal is generated in response to the detected power level of the first signal through the receive chain of the first transmit/receive circuit being below a predetermined threshold, and the second reception power level signal is generated in response to the detected power level of the second signal through the receive chain of the second transmit/receive circuit being below the predetermined threshold.

17. The circuit of claim 15, wherein the first reception power level signal is generated in response to the detected power level of the first signal through the receive chain of the first transmit/receive circuit being above another predetermined threshold, and the second reception power level signal is generated in response to the detected power level of the second signal through the receive chain of the second transmit/receive circuit being above another predetermined threshold.

18. A phased array beamformer circuit connectible to an array of antenna elements, the circuit comprising:
one or more of splitter-combiners each including a combined port and one or more split ports; and
one or more transmit/receive circuits each connected to a respective one of the split ports of the splitter-combiners and to a respective one of the antenna elements of the array, each of the transmit/receive circuits including a transmit chain and a receive chain, gain of a given one of the receive chain being adjustable in response to a reception signal power level through the receive chain being lower than a first predetermined threshold or higher than a second predetermined threshold.

19. The circuit of claim 17, wherein gain of the given one of the receive chains is decreased in response to the reception signal power level through the given one of the receive chains being lower than the first predetermined threshold or higher than the second predetermined threshold.

20. The circuit of claim 19, wherein gain of another one of the receive chains of a different transmit/receive circuit is increased in response to the reception signal power level through the given one of the receive chains being lower than the first predetermined threshold or higher than the second predetermined threshold.
